(19) United States
(12) Patent Application Publication
(10) Pub. No.: US 2024/0119506 A1
(43) Pub. Date: Apr. 11, 2024

(54) SYSTEM FOR AUTOMATIC CREATING AND UPDATING THE END-USER SCREEN IMAGES BASED ON AUTOMOTIVE DATA SOURCES

(71) Applicants: Sam Hijazi, Austin, TX (US); Christopher Reynoso, Austin, TX (US); Ahmad El Solh, Austin, TX (US); Chadwick Shaun Blain, Austin, TX (US)

(72) Inventors: Sam Hijazi, Austin, TX (US); Christopher Reynoso, Austin, TX (US); Ahmad El Solh, Austin, TX (US); Chadwick Shaun Blain, Austin, TX (US)

(21) Appl. No.: 17/961,017

(22) Filed: Oct. 6, 2022

(51) Int. Cl. G06Q 30/06

(52) U.S. Cl. CPC G06Q 30/0633; G06Q 30/0613

(57) ABSTRACT

A software-based computer system that allows the user to add images from various automotive data sources to the dealer inventory and then automatically create all necessary end-user screen images being uploaded to dealer's computer terminals and simultaneously being syndicated to all third-party listing sites. Furthermore, the computer system can regularly checking/monitor all relevant automotive data sources and automatically update the final end-user screen images on both the dealer and the third-party platforms once a change from automotive data sources is detected.

### FIELD OF THE INVENTION

The present invention disclosure generally relates to a computer system for automatically creating and updating the end-user screen images based on a variety of automotive data source images.

### BACKGROUND OF THE DISCLOSURE

Dealer's inventory vehicles usually need to be sent to hundreds of third-party website listings on a recurring schedule (e.g. daily). Online vehicle sales, in particular for used vehicles, have been playing an important role for car dealers' businesses. Unfortunately, the information stored relating to used vehicles is often not timely updated and is therefore incomplete, inconsistent, and even often contains incorrect information. This can lead to the online customers confusion and frustration. Therefore, there is a market demand to develop a new and improved system benefiting both car dealers and potential customers.

Further, vehicle data or documents from a third party company can be in the form of screen image captures, such as Monroney Label, CARFAX report, AutoCheck Report, J.D. Power Report, Kelly Blue Book Report, or any other report/sheet/label. Many of these vehicle related documents change often, (e.g. when a vehicle is listed the CARFAX Report may show the vehicle is a one owner vehicle). Changes in vehicle data can affect the value of a vehicle significantly. Therefore, there is a further market demand to develop an automated system for automatically updating the end-user screen images at the various vehicle sale sites or dealerships.

The systems and methods disclosed herein presents an innovative computer system and method that allow the user to add images from automotive data sources into a vehicle document center at a car dealership. Subsequently, the system can search one or more vehicle database to create end-user screen images that are uploaded to dealer computer terminals and simultaneously syndicated to third-party listing sites. Furthermore, the system can regularly check/monitor automotive data source images and automatically update the final end-user screen images on both dealer and the third-party platforms once a change from automotive data sources is detected. All the processes as above described in this invention can be carried out automatically and result in a collection of complete, consistent, and correct information that will greatly improve the online sale performance and enhance online customers' buying experiences. Additional benefits of the systems and methods of this innovation allow users to instruct the system to create or acquire a copy of the report and store it as an image in inventory. This report can then be syndicated out automatically so it can be viewed on third-party listing sites (e.g. Autotrader, Cars.com, CarGurus.com, and/or others). The report can be amended or changed over time and the systems and methods of this innovation can automatically detect the change and timely update the images to prevent the situation that the third-party advertising sites are displaying inaccurate vehicle data.

Traditionally, updating information of this sort was done purely by human labor and did not provide any form of fully automatic updating. Prior art reference U.S. Pat. No. 11,232,298 by Abraham discloses a method for automatically extracting data from scanned documents and generating electronic documents based on the information. Prior art reference U.S. Pat. No. 11,304,057 by Scholl discloses a method for data extraction based on stored vehicle information. Prior art reference US Patent Publication #2014/0279868 by Astorg discloses a method for generation of informational packets with automatic updating of information for accurate informational packets at a dealership for prospective buyers.

### SUMMARY OF THE INVENTION

The innovation described herein is related to a computer software or computer program that allows the user to add images from various automotive data sources to a vehicle document center at a car dealer and then to automatically create all necessary end-user screen images being uploaded to dealer computer terminals while simultaneously being syndicated to all third-party listing sites. Furthermore, the computer system can regularly check/monitor all relevant automotive data sources and automatically update final end-user screen images on both dealer and third-party platforms once a change from automotive data sources is detected.

In some embodiments of this invention, a computer system is described for automatically generating end-user screen images based on automotive data sources. This can include a function allowing the user to add images from various automotive data sources into the vehicle document center at a dealer and automatically determining a matching vehicle. Another function can then allow the system to automatically create all necessary end-user screen images that are uploaded to dealer computer terminals and simultaneously being syndicated to all third-party listing sites.

In some embodiments, a computer system automatically updates end-user screen images based on automotive data sources. This can include regularly checking/monitoring relevant automotive data sources and automatically updating final end-user screen images on both dealer and third-party platforms once a change from automotive data sources or internally generated data is detected by a software-based computer program within the computer system of this invention.

In some embodiments, a computer system and method for automatic creating and updating end-user screen images based on automotive data sources, allowing the user to automatically add images to the vehicle document center at a dealer that are selected from various automotive data sources. The system can automatically determine a matching vehicle from dealer inventory for the added images and automatically create all necessary end-user screen images being uploaded to dealer computer terminals, simultaneously the system will automatically create an image compatible file and syndicate it to third-party listing sites. Further, the system can regularly check/monitor source data or location data for any changes of the newly created images and automatically update the final end-user screen images on both dealer and third-party platforms with the help of a software-based program within the computer system once a change from automotive data sources is detected.

Some features of the system for automatic creating and updating the end-user screen images based on automotive data sources (ADS) herein are the ability to automate dynamic changes of all vehicle documents for business operations at a vehicle dealer. Included are the concept of an automatic input system of a process with automatic-insertion rules, as compared to the traditional method for manually dragging and dropping each desired ADS image into a position. Another aspect is a routine, periodic checking/monitoring function that automatically updates end-user screen images based on detected changes in data from automotive data sources. Also included is an automatic syndication system with two computer programming data/process loops that update end-user screen images at third party listing websites, either based on a triggering event by a scheduling timer for feed syndication or based on an instant on-demand feedback mechanism for feed syndication. Also included is an automatic creation system with two computer programming process/data loops that automatically updates end-user screen images based on a request from a user or a browser.

### BRIEF DESCRIPTION OF THE DRAWINGS

The following Figures will demonstrate automatic functions for achieving automatic creating and updating the end-user screen images based on automotive data sources (ADS). The first three figures focus on the general method to achieve automatic creating and updating the end-user screen images based on automotive data sources (ADS) and the remaining seven figures illustrate the computer program flow charts and the logic behind each automatic operation as presented in this invention.

FIG. 1 is a schematic diagram demonstrating the functions of automatically creating end-user screen images once an image is selected from automotive data sources, according to some embodiments;

FIG. 2 is a schematic flow diagram demonstrating the functions of automatically updating the end-user screen images once a change is detected from automotive data sources, according to some embodiments;

FIG. 3 is a functional overview of the software-based computer system, according to some embodiments;

FIG. 4 is a schematic flow chart demonstrating an interactive user session for editing information pertaining to a specific vehicle in order to process it with auto-insertion rules, based on the system function of automatic insertion from automotive data sources, according to some embodiments;

FIG. 5 is a computer programming flow chart using a method of receiving push updates from a remote system to update information with auto-insertion rules for the automotive data source images at a dealer website and/or third-party listing sites, according to some embodiments;

FIG. 6 is a functional flow chart showing a process with auto-insertion rules for automatically inserting ADS images for a vehicle, according to some embodiments;

FIG. 7 illustrates a routine periodic checking system for automatic updating end-user screen images based on automotive data sources (ADS), according to some embodiments;

FIG. 8 shows a method of receive push updates from a remote system (RPRS) to achieve automatic routine, periodic checking and automatically updating end-user screen images, according to some embodiments;

FIG. 9 demonstrates an automatic updating program for completing a syndication task, according to some embodiments;

FIG. 10 demonstrates how end-user screen images that are displayed on dealership websites are automatically created, according to some embodiments; and

FIG. 11 illustrates a system architecture diagram.

### DETAILED DESCRIPTION OF THE INVENTION DISCLOSURE

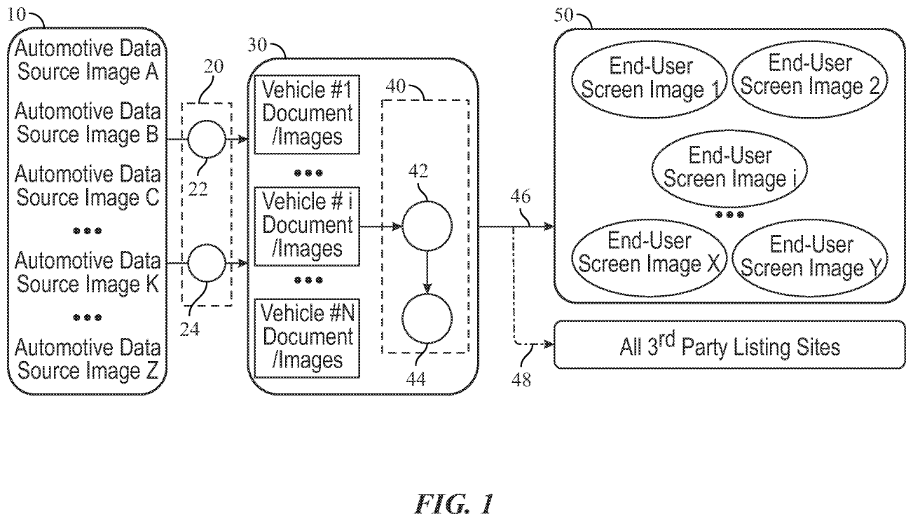

FIG. 1 is a schematic diagram demonstrating the functions of the innovative system and methods as described herein, focusing on automatic creating the end-user screen images based on the selected images from automotive data sources (ADSs).

Block 10 in FIG. 1 represents a database containing multiple automotive data sources, for example, from Automotive Data Source Image A to Automotive Data Source Image Z, where each automotive data source image may be in an information form (e.g. a Monroney Label, CARFAX report, AutoCheck Report, J.D. Power Report, Kelly Blue Book Report, or any other report/sheet/label). A user can view and select any image in the database using navigation and search tools.

The dashed-line Block 20 in FIG. 1 shows an image uploading unit. For example, Automotive Data Source Images B and K can be requested to be added into a vehicle inventory system. Circle 22 shows an action by pressing an ADS button related to an Automotive Data Source Image B to the image uploading unit at Block 20. Similarly, circle 24 indicates an action, e.g. pressing an ADS button related to Automotive Data Source Image K to the image uploading unit at Block 20.

Block 30 in FIG. 1 shows a computer system for automatic creating end-user screen images to be shown on a user interface display in Block 50 (e.g. a monitor of a computer terminal) and can contain dealer inventory database (i.e. vehicle document center at a dealer) with all documents and images for each vehicle (e.g. from Vehicle #1 to Vehicle #N). Inside Block 30, dashed Block 40 represents a computer program that performs the function at Block 42 for automatically matching and finding a corresponding vehicle, i.e., Vehicle #i based on the selected Automotive Data Source Images B and K. Further, the computer program performs the function at Block 44 of searching available databases to automatically create end-user screen images and then performing Action 46 of uploading all of the images. As such, End-user Screen Images 1 to Y are uploaded onto a dealer's computer terminal at Block 50. At the same time, the computer program automatically creates an image compatible format file and performs Action 48 to syndicate the generated end-user screen images to all third-party listing websites, as shown in Block 50.

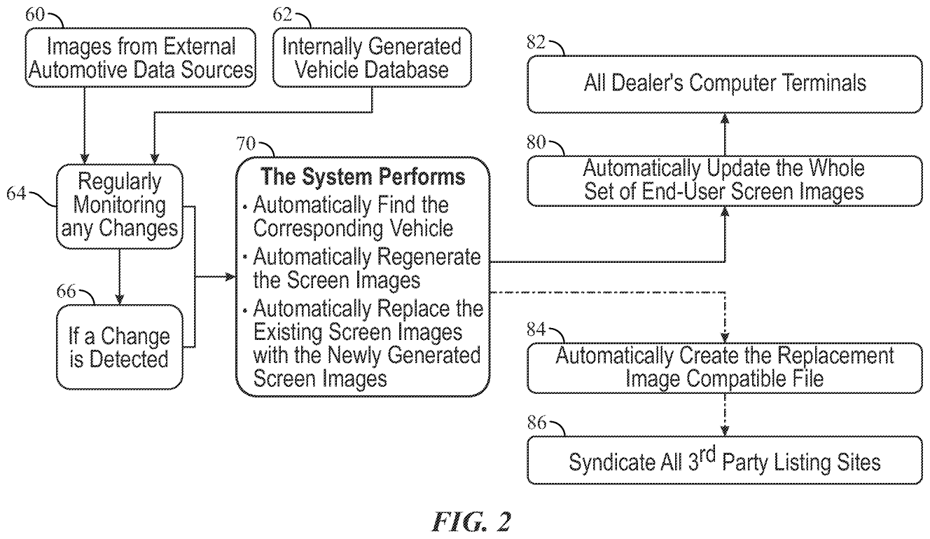

FIG. 2 shows a schematic flow diagram demonstrating functions of various embodiments, including automatically updating an end-user screen images based on the detected change of the previously selected Automotive Data Source Images B and K as illustrated in FIG. 1.

Once end-user screen images in Block 50 (FIG. 1) are created, uploaded to the dealer's computer terminals, and synchronized to third party listing websites, there may be a change in vehicle information from automotive data sources, for example, a new J.D. Power Report or a new Kelly Blue Book Report. As such, a mechanism is included that regularly checks/monitors vehicle data related to previously created end-user screen images. Software programs described herein can also automatically update end-user screen images once a change is detected through checking/monitoring processes.

As shown in FIG. 2, Block 60 contains images from external automotive data sources and Block 62 is an internally generated vehicle database. Block 64 performs the function of regularly monitoring any changes of the data within Blocks 60 and 62, and then Block 66 makes a judgement if a change is detected.

Once a change is detected on Block 66, the computer system in Block 70 can perform one or more actions (e.g. three automatic actions or more). For example, automatically finding the corresponding matching vehicle, automatically regenerate the end-user screen images, and automatically replace the existing screen images with the newly generated screen images.

Block 80 shows that the system at Block 70 can automatically upload and update end-user screen images for a dealer's computer terminals at Block 82. Further, Block 84 shows that the system at Block 70 automatically creates a replacement image compatible file to synchronize and syndicate out the end-user screen images to third-party listing websites at block 86.

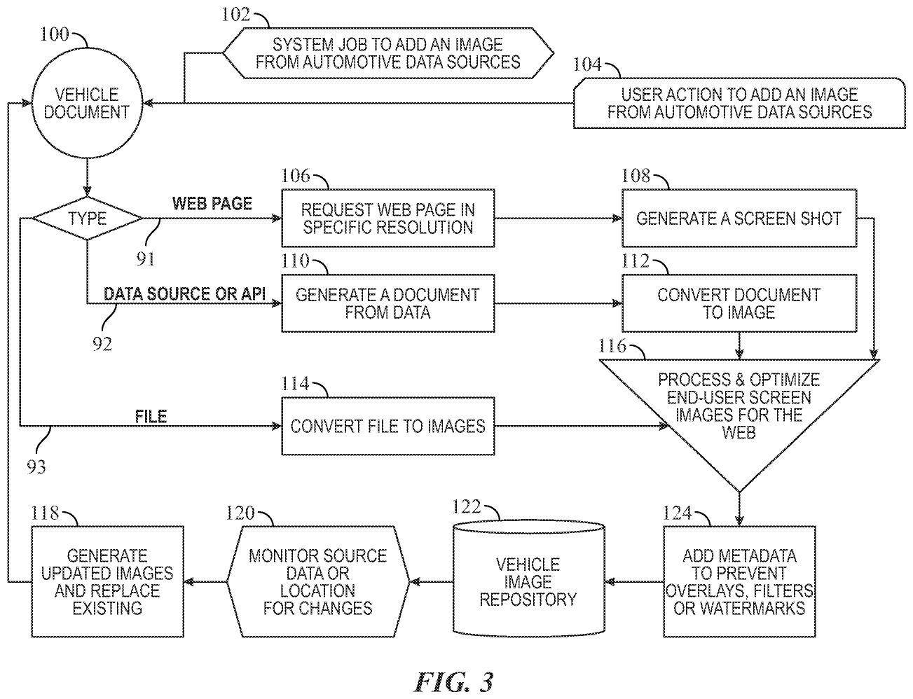

FIG. 3 shows an overview of a software-based computer system. Block 100 for a vehicle document represents a vehicle document center at a dealership that contains relevant vehicle documents. Block 102 represents a function for a system job to add an image from automotive data sources into a vehicle document at Block 100. Block 104 represents a function of a user action to add an image from the automotive data sources into Vehicle Document at Block 100 by selecting or otherwise interacting with a user interface.

Vehicle Document at Block 100 in FIG. 3 can be classified into three major types, such as Web Page, Data Source or Application Programming Interface (API), and File, all of which are commercially available. Line 91 represents sub-types under Web Page, including at least AutoCheck Report and CARFAX Report. Line 92 represents sub-types under Data Source or API (Application Programming Interface), including, but not limited to, Buyers Guide, Customer Window Sticker, Kelley Blue Book Report, and J.D. Power Report. Line 93 represents sub-types under File including at least Factory Window Sticker, Monroney Label, Purchase Order, Registration Documents and Reproduction Window Sticker.

As shown in FIG. 3, to create a set of end-user screen images from a web page, a sub-type under Web Page at Line 91 can be fed into Block 106, which requests a web page in specific resolution. Consequently, Block 108 can then generates a screen shot. Similarly, to create a set of end-user screen images from a data source or API, a sub-type under Data Source/API at Line 92 can be fed into the Block 110 which generates a document from available data and then consequently Block 112 which converts the document to an image. For any sub-type under File at Line 93, the Block 114 can directly convert files to images.

Intermedia images created under different types of Vehicle Document at Block 100 can be processed and optimized at Block 116 in FIG. 3 to create all the end-user screen images ready for website use. The system can carry out other actions at Block 124, for instance, adding metadata to prevent overlays, filters, watermarks for purposes of producing high quality web display, or others. As the following step after the actions at Block 124, images can be stored at Block 122 Vehicle Image Repository.

Shown in Block 120 in FIG. 3 is a software-based monitor module inside the computer system. At Block 120 the software program can regularly check/monitor if there is a change of data as compared to that stored inside Vehicle Image Repository at Block 122 containing the created end-user screen images. If and once a change is detected by the computer system, Block 118 can trigger an action requesting the computer system 70 (FIG. 2) to generate a set of updated images and replace existing images. The newly updated images can be updated for the Vehicle Document Center at Block 100. The computer system 70 (FIG. 2) can then automatically update and upload the entire set of end-user screen images to the dealer's computer terminals, and automatically create one or more replacement image compatible files to synchronize out the end-user screen images to third-party listing sites.

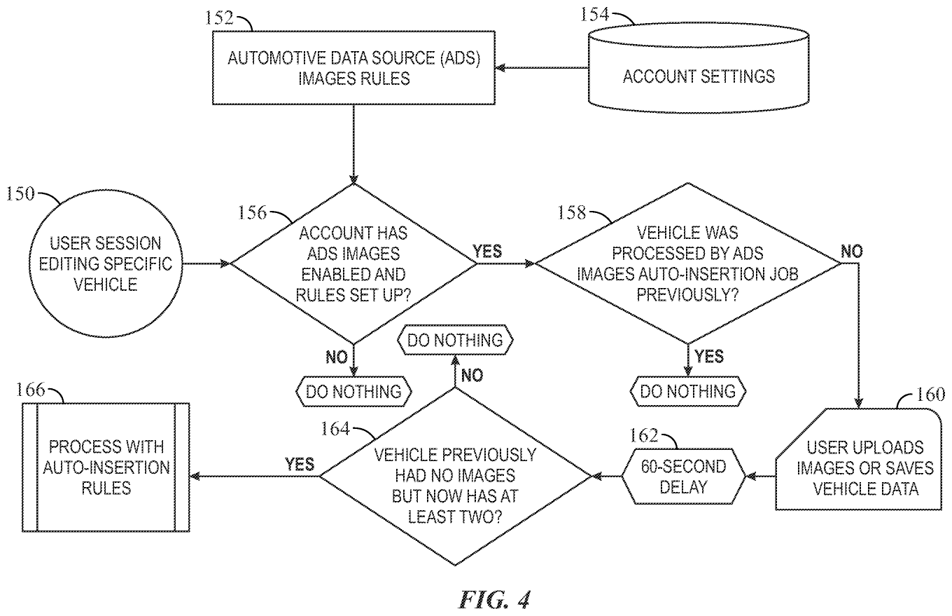

An automatic process with auto-insertion rules can be part of the system and one of the unique features of the system for automatic creating and updating the end-user screen images based on automotive data sources (ADS). FIG. 4 illustrates an interactive user session for editing specific vehicle information/data to process with auto-insertion rules based on the system function of automatic insertion capability of the automotive data sources (ADS). The software-based programming function performs the behavior of automatic insertion for the ADS image system. Rather than the user manually dragging and dropping each desired ADS image into a position in the list of ADS images, the system can automatically perform functions based on image rules stored in the account settings.

As shown In FIG. 4, a user has a set of ADS image rules at Block 152 related to accounting settings at Block 154 from an individual user. The user session at block 150 allows an individual user to edit information/data for a specific vehicle. The user can view and select an ADS button on the user display screen of a user device to view available ADS images depending on access and subscriptions to external services. The system can perform a function to automatically insert the ADS images from Block 152 based on the account settings at Block 154 which are stored at a dealer. For instance, CARFAX can be classified at Position 6, Kelly Blue Book can be classified at Position 9, and Monroney label can be classified at Position 12. Automatically, the system has can add updated information available for the vehicle, which is illustrated at Block 156, if the user account at Block 154 has ADS images enabled and rules set up at Block 152. At Block 158 the system can check if the vehicle was previously processed by ADS image automatic insertion job, and, if not, the user can upload images or save vehicle data at Block 160. The system can then put a delay at Block 162 (e.g. 60-seconds) to ensure the data and images have been properly uploaded and are in place. Then the system can perform the function at Block 164 to check if the vehicle previously had no images but now has an appropriate number of images (e.g. at least two images). If the prerequisite set in Block 164 is satisfied, the system can process with auto-insertion rules at Block 166.

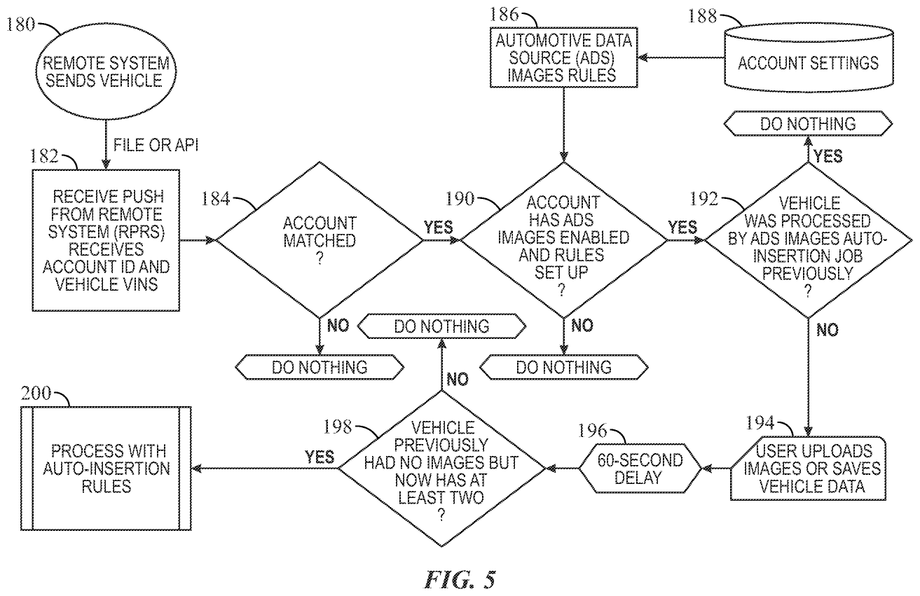

As an optional alternative to the methods presented in FIG. 4, FIG. 5 shows a computer programming flow chart using a method of Receive Push from Remote System (RPRS) to achieve a process using auto-insertion rules for ADS images at a dealer website or third-party listing site(s). A remote system at Block 180 can send a vehicle file or API (Application Programming Interface) to the system for automatic creating and updating the end-user screen images based on automotive data sources (ADS) of this invention. Once the software-based RPRS at Block 182 receives appropriate information (e.g. account ID and vehicle VINs (vehicle identification numbers)), the system at Block 184 automatically checks whether the account is matched with an account stored at the dealer database. For a positively matched account, the remote system at Block 180 should have a set of automotive data source image rules at Block 186 linked to the accounting settings at Block 188. The remote system at block 180 can edit a specific vehicle and a user can select an ADS button on the user interface screen of a user device to view available ADS images, depending on access and subscriptions to external services.

The system in FIG. 5 performs the function of automatically inserting ADS images based on the settings stored at a dealer (e.g. for CARFAX—Position 6, for Kelly Blue Book—Position 9, for Monroney—Position 12) and then the system can automatically add what the updated information/data available for the vehicle, which is illustrated at Block 190. At Block 190 the system confirms whether the remote system at Block 180 has account settings at Block 188 and ADS images enabled and rules set up at Block 186. At Block 192 the system checks if the vehicle was previously processed by ADS image auto-insertion job, and, if not, the remote system can upload images or save vehicle data at Block 194. The system can then put a delay (e.g. 60-seconds) at Block 196 to ensure all the data and images have been properly uploaded and saved into the vehicle data at a dealer. Then the system can perform the function at Block 198 of checking whether the vehicle previously had no images but now has images (e.g. at least two images). If the prerequisite as set in Block 188 is satisfied, the system will process with auto-insertion rules at Block 200.

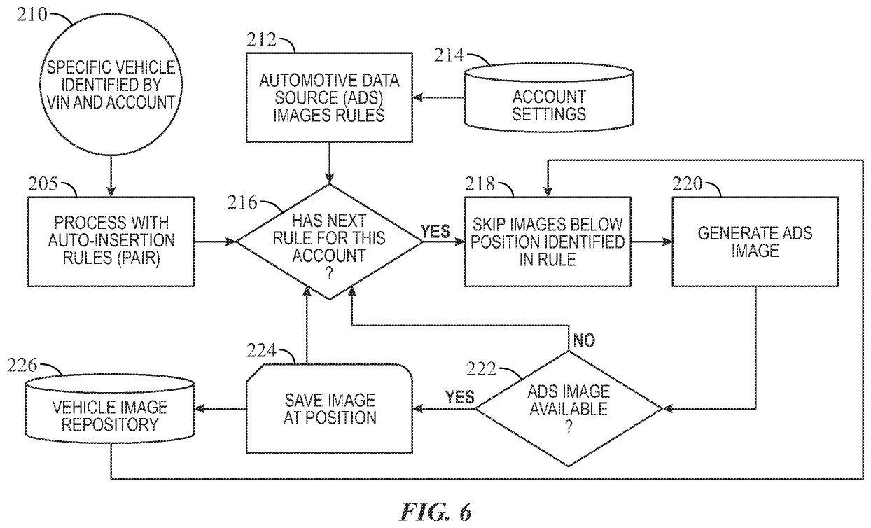

The systems or the methods presented in both FIG. 4 and FIG. 5 use a function called as Process with Auto-Insertion Rules (PAIR), Block 166 in FIG. 4 and Block 200 in FIG. 5. The function of this unique process with auto-insertion rules shows how the system knows when to automatically insert ADS images for a vehicle. As such, the process with auto-insertion rules determines when to automatically insert ADS images for a vehicle. FIG. 6 shows a Process with Auto-Insertion Rules (PAIR) Block 205 and starts at Block 210 with a request for a specific vehicle identified by VIN and account. In FIG. 6, Block 216 is a PAIR data/process loop structure in a software-based computer program where the PAIR loop structure at Block 216 receives the information from the specific vehicle identified by VIN and account at Block 210, the ADS images at Block 152 which is linked to the account settings at Block 152 stored at a dealer database, as well as two feedback lines. That is, the feedback line 244 for the ADS images available at Block 222 and the feedback line 248 for the save image at position at Block 224. The loop function at Block 216 will continue to iterate each rule for all the rules in the present account. If there is still a “next rule” in the loop structure at Block 216, the iteration will continue to perform the function at Block 218 to skip images below a position identified according to a rule, and the system will generate a corresponding ADS image at Block 220. The system will check at Block 222 if the ADS image generated at Block 220 is available. If the generated ADS image at Block 220 is not available, the system will send the unavailable information to the loop structure 216 for the purpose of continuing iteration. If the generated ADS image at Block 220 is available, the system will save the image at present position at Block 224. The saved image at a present position will also be sent to the vehicle image repository at Block 226 for storage. At the same time, the saved image at position will be sent to the Loop structure at Block 216. The vehicle image repository at Block 226 will provide the updated vehicle information to the skip images function below in a position identified in rule Block 218. This is one of the operative steps within the loop structure operation at Block 216.

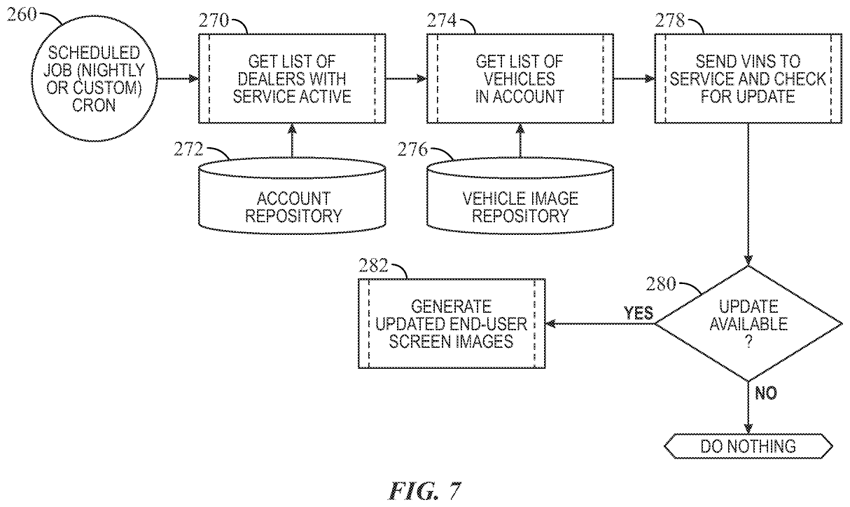

The automatic updating of end-user screen images is another unique feature of the system for automatic creating and updating the end-user screen images based on automotive data sources (ADS). FIG. 7 illustrates a routine periodic checking function that regularly checks/monitors whether there is a change in relevant automotive data sources. Block 260 shows a function for scheduled job with CRON mechanism, which is defined as a list of commands to a computer operating application server to be executed at a specified time (e.g. nightly or at custom time). Within Block 260 with CRON, each command of the computer operating application server can be executed when its triggering time arrives. Examples of items to be checked on either scheduled job or custom request are J.D. Power, Kelley Blue Book, Monroney labels, or others. Once such a trigger happens, Block 270 automatically gets a list of dealers with active service supported by the account repository at Block 274. Then the system automatically receives or calls a list of vehicles in the associated account supported by the vehicle repository at Block 276. Next, the system automatically sends VINs (vehicle identification numbers) to service and checks for updates at Block 278. Then the system automatically checks at Block 280 whether an update is available and, if yes, the system will automatically generate updated end-user screen images at Block 282. The whole set of updated end-user screen images can then be automatically uploaded and updated at the dealer's computer terminals. Simultaneously, the system can automatically create a replacement image compatible file to synchronize and syndicate the end-user screen images to third-party listing websites. If an update is not available, the system at Block 280 does not update.

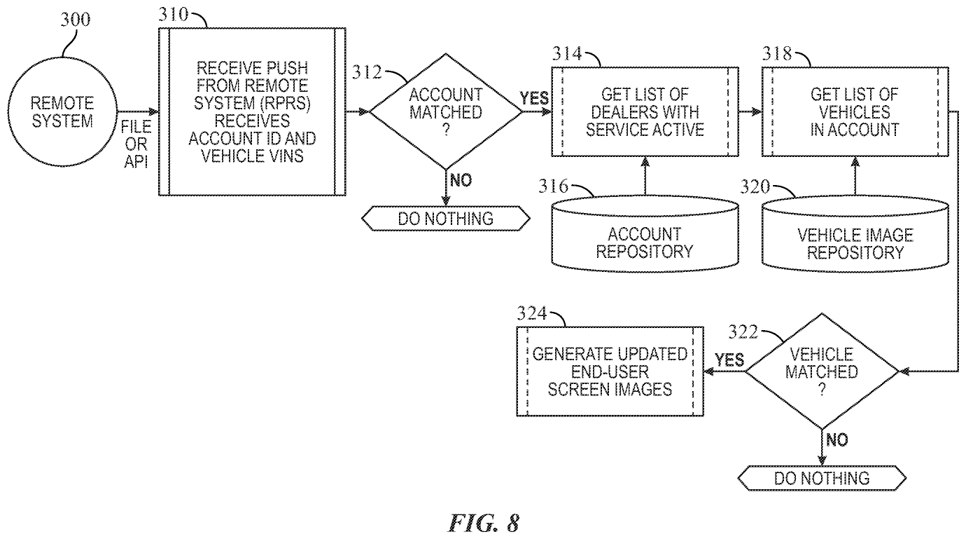

As an alternative for routine periodic checking system as demonstrated in FIG. 7, the system for automatic creating and updating end-user screen images based on automotive data sources (ADS) can perform computer system functions using a Receive Push from Remote System (RPRS) method (as shown in FIG. 8) to achieve automatic routine periodic checking/monitoring and automatic updating end-user screen images once a change in automotive data sources is detected. The RPRS method allows remote access to the system via a network and through receiving a push from a remote system that is requesting to monitor or check ADS images. If there is a change in ADS images, the remote system can automatically update the relevant images and automatically upload the updated end-user screen images at both the dealer end and third party websites. Example third party website services are AutoCheck and CARFAX. A remote system at Block 300 can send a vehicle file or API (Application Programming Interface) to the system via a network to automatically create and/or update end-user screen images based on ADS. Once the software-based RPRS at Block 310 (as presented in FIG. 8) receives account ID and vehicle VINs, the system at Block 312 automatically checks whether the input account is matched with an account stored at the dealer database. If the input account does not match, the system at Block 312 does not update. For a matched account from Block 312, the system at Block 314 can obtain the account details with the data support from the account repository at Block 316. Then the system can retrieve a list of vehicles in that matched account at Block 318 with data support from the account repository at Block 320. Further, the system can check at Block 322 if the vehicle list in that account is matched with the corresponding vehicles at the present end-user screen images. If the vehicle list in that account does not match the vehicle currently listed at the end-user screen images, the system does not update. If the Block 322 determines that the vehicle list in that account matches with that the current corresponding vehicle end-user screen images, the system at Block 324 can automatically generate new screen images to replace existing ones and automatically upload all updated end-user screen images at dealer sites. Simultaneously, the system can automatically create a replacement image compatible file to synchronize and syndicate the end-user screen images at third-party listing websites.

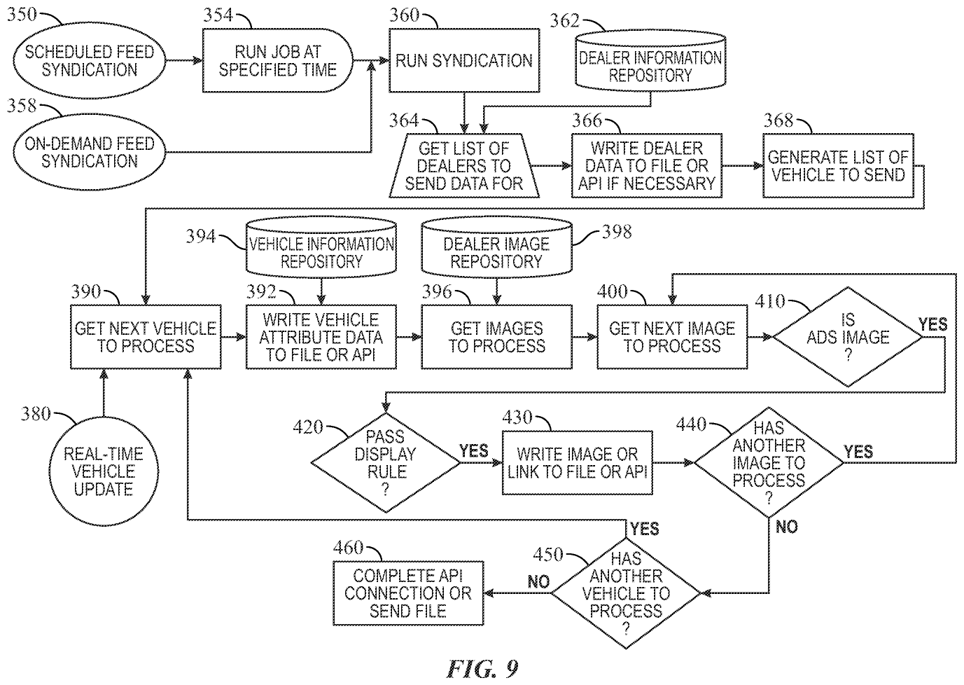

The automatic vehicle syndication function for updating of all end-user screen images at third party listing website is another unique feature of the system for automatic creating and updating the end-user screen images based on automotive data sources (ADS). FIG. 9 demonstrates the work principle of an automatic updating program for completing a syndication task. In a case for a scheduled feed syndication task at Block 350, the system runs a job at a specific time at Block 354. Then, the system can run a software-based syndication computer program at Block 360 for vehicle images related to different automotive data sources (ADS) (e.g. Autotrader, Cars.com, CarGurus, or others). In another case for an on-demand feed syndication task at Block 358, the demand can be directly sent to the software-based syndication computer program at Block 360 for the same vehicle ADS images from different automotive data sources as the case for the above mentioned on-demand feed syndication task at Block 358, and with same examples (e.g. Autotrader, Cars.com, CarGurus, or others).

For either the scheduled feed syndication or the instant on-demand feed syndication in FIG. 9, the software-based computer program at Block 360 can automatically run the syndication operation to get a list of dealers to send the syndicated data at Block 364 with the data support from dealer information repository at Block 362, and then the syndication program can write dealer data to the vehicle file or API (Application Programming Interface) if necessary at Block 366 and generate a list of vehicles to send at Block 368.

Once the list of vehicles is generated at Block 368 (as shown in FIG. 9), the syndication program can perform two programming loops to iterate each listed vehicle for processing in the first loop (Block 390 to Block 450) and then iterate each vehicle image under the vehicle in subject in the second loop (Block 400 to Block 440). Together with the real-time vehicle update at Block 380 and the list of vehicles generated to send at Block 368, the syndication program can perform a loop function at Block 390 to Block 450 to process each vehicle on the listed vehicles from Block 368. Once Block 390 receives a command from the computer program to process the next vehicle, it can write vehicle attribute data to the vehicle file or Application Programming Interface at Block 392 with data support from vehicle information repository at Block 394. Then it can acquire or generate the associated vehicle images to process at Block 396 with the data support from vehicle image repository at Block 398.

Once all relevant images are obtained from the vehicle being processed at Block 396, the syndication program can perform a loop to iterate each image under that vehicle to process at Block 400. The system can check at Block 410 if the vehicle image to be processed from Block 396 is a standard image that meets automotive data sources (ADS) image rules as described in FIG. 4. In other words, Block 410 can check if it is an ADS image and meets ADS image rules that has been classified and already stored at a dealer vehicle database, (e.g. CARFAX at Position 6, Kelly Blue Book at Position 9, and Monroney at Position 12). If an ADS image obtained at Block 410 is a standard ADS image and meets the ADS image rules, the ADS image can be forwarded to Block 420 to check if the image can pass the display rules which exist to provide a safeguard against displaying negative data. For instance, a CARFAX or AutoCheck report can be excluded if negative data is included. A book sheet like Kelley Blue Book, J.D. Power, etc. may not be displayed if the vehicle's price is higher than the recommended price. Thus, even an ADS image is a standard ADS image and meets the ADS image rules it still needs to pass the display rules at Block 420. The system can automatically check if an ADS image meets the display rule. Once an ADS image passes the display rule at Block 420, it can be sent to Block 430 for writing the image or linking the image to a vehicle file or API. Then, the syndication program can perform an image loop to check if there is another image that needs to be processed. If the answer is a yes, the system continues the Block 400 to Block 440 loop until the last available image is processed. If the answer is a no, the system continues the Block 390 and Block 450 loop until the last available vehicle is processed. Once the loop for vehicles at Block 390 and Block 450 is completed, the system completes API connection or sends the vehicle file. All the processes shown in FIG. 9 can be automatically performed once the system is either triggered by the scheduled time for feed syndication or has received an instant on-demand request for feed syndication by a user.

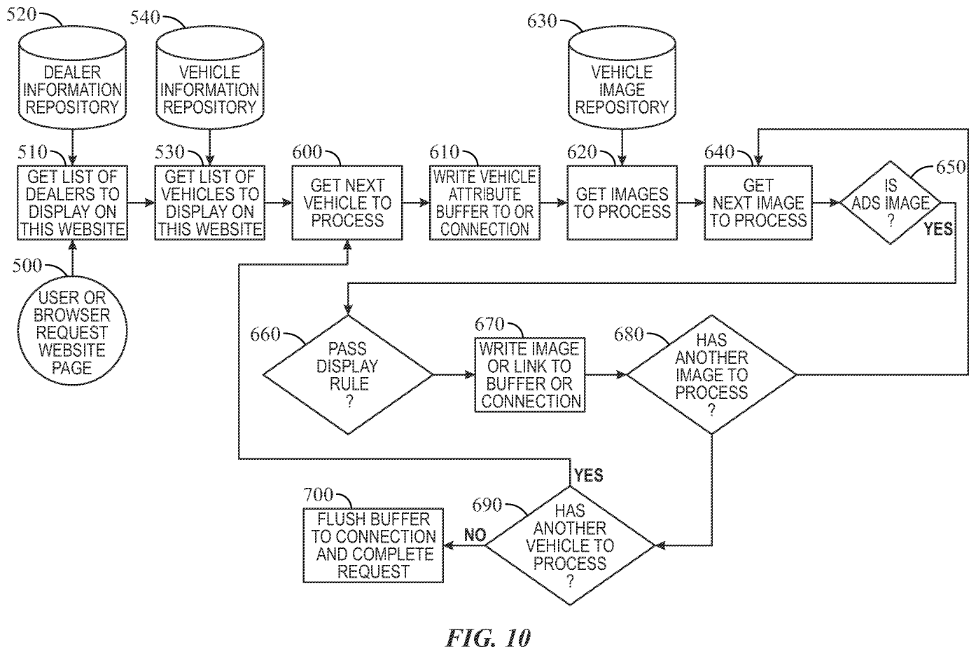

FIG. 10 demonstrates how end-user screen images that are displayed on dealership website can be automatically created. Automatically creating vehicle website pages upon a request from a user/browser who will, at Block 500, receive a relevant dealership web site that uses the vehicle management platform created based on the system for automatic creating and updating the end-user screen images based on automotive data sources (ADS). At Block 510, the user or browser can generate, acquire, or receive a list of dealers to display on a dealership website with the data support of dealer information repository at Block 520. Further, the user or the browser can generate a list of vehicles to display on the dealership web site at Block 530 with the data support from vehicle information repository at Block 540. Then the computer program can introduce a vehicle loop from Block 600 to Block 690 to process each vehicle from a list of the vehicles obtained at Block 530.

The computer program at Block 600 starts a first looping program to iterate each vehicle until reaching the last one in the list of vehicles from Block 530, and the system at Block 610 writes the vehicle attributes to a buffer or a connection, and then the system at Block 620 obtains a set of images to process with the data support from vehicle image repository at Block 630.

In FIG. 10, the next step can include the system beginning a second looping program at Block 640 to iterate each image obtained at Block 620 for the vehicle until reaching the last one in the list of images from Block 620. Then the system can check at Block 650 if the vehicle image to be processed from Block 640 are standard images that meet automotive data sources (ADS) image rules that have been classified and are already stored at a dealer vehicle database (e.g. CARFAX at Position 6, Kelly Blue Book at Position 9, and Monroney at Position 12). If an ADS image obtained at Block 620 is a standard ADS image and meets the ADS image rules, the ADS image will be forwarded to Block 660 to check if the image can pass the display rules to guarantee a safeguard against displaying negative data. For instance, a CARFAX or AutoCheck report can be excluded if negative data is included. A book sheet like Kelley Blue Book, J.D. Power, etc. may not be displayed if the vehicle's price is higher than the recommended price. Thus, even though an ADS image is a standard ADS image and meets the ADS image rules, it still needs to pass the display rules at Block 660. The system can automatically check if an ADS image meets the display rule. Once an ADS image passes the display rule at Block 660, it can be forwarded to Block 670 for writing the image or linking the image to a buffer or connection. Then the system program can perform an image loop to check if there is another image that needs to be processed. If the answer is a yes, the system continues the Block 640 to Block 680 loop until the last available image is processed. If the answer is no, the system can move from Block 600 to the Block 690 loop until the last available vehicle is processed. Once the loop for vehicles from Block 600 to Block 690 loop is completed, the system at Block 700 can flush a buffer to connection and complete the request from a user or a browser at Block 500. The processes shown in FIG. 10 can be automatically performed once the system has received the request from a user or a browser at Block 500. As a result, in the end the system automatically creates vehicle end-user screen images upon the instant request from a user or a browser.

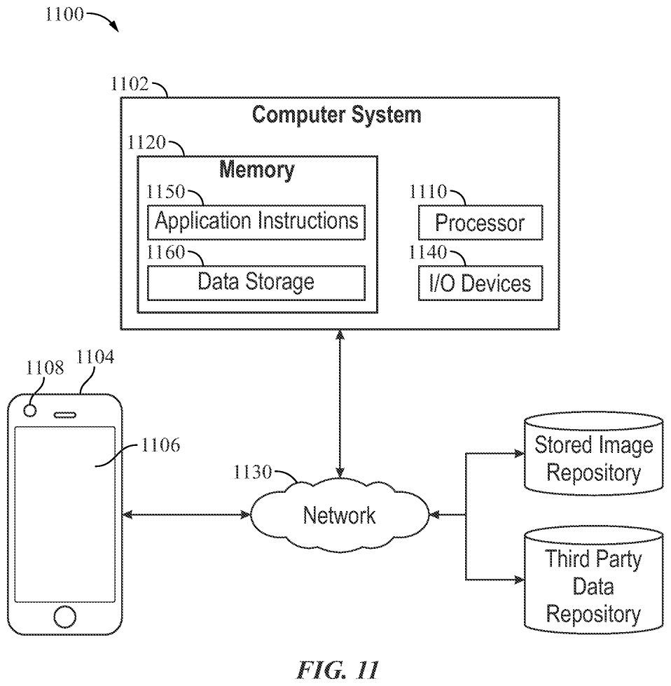

FIG. 11 illustrates a system architecture diagram 1100, including a computer system 1102, which can be utilized to provide and/or execute the processes described herein in various embodiments. The computer system 1102 can be comprised of a standalone computer or mobile computing device, a mainframe computer system, a workstation, a network computer, a desktop computer, a laptop, a tablet, a smartphone, a videogame console, or the like. The computer system 1102 includes one or more processors 1110 coupled to a memory 1120 via an input/output (I/O) interface. Computer system 1102 may further include a network interface to communicate with the network 1130. One or more input/output (I/O) devices 140, such as video device(s) (e.g., a camera), audio device(s), and display(s) are in operable communication with the computer system 1102. In some embodiments, similar I/O devices 1140 may be separate from computer system 1102 and may interact with one or more nodes of the computer system 102 through a wired or wireless connection, such as over a network interface.

Processors 1110 suitable for the execution of a computer program include both general and special purpose microprocessors and any one or more processors of any digital computing device. The processor 1110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive). 10531A network interface may be configured to allow data to be exchanged between the computer system 1102 and other devices attached to a network 1130, such as other computer systems, or between nodes of the computer system 1102. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel storage area networks (SANs), or via any other suitable type of network and/or protocol.

The memory 1120 may include application instructions 1150, configured to implement certain embodiments described herein, and at least one database or data storage 1160, comprising various data accessible by the application instructions 1150. In at least one embodiment, the application instructions 1150 may include software elements corresponding to one or more of the various embodiments described herein. For example, application instructions 1150 may be implemented in various embodiments using any desired programming language, scripting language, or combination of programming languages and/or scripting languages (e.g., C, C++, C #, JAVA®, JAVASCRIPT®, PERL®, etc.).

The steps and actions of the computer system 1102 described in connection with the embodiments disclosed herein may be embodied directly in hardware, in a software module executed by a processor, or in a combination of the two. A software module may reside in random-access memory (RAM), flash memory, read-only memory (ROM) memory, erasable programmable read-only memory (EPROM) memory, electrically erasable programmable read-only memory (EEPROM) memory, registers, a hard disk, a solid-state drive (SSD), hybrid drive, dual-drive, a removable disk, a compact disc read-only memory (CD-ROM), digital versatile disc (DVD), high definition digital versatile disc (HD DVD), or any other form of non-transitory storage medium known in the art or later developed. An exemplary storage medium may be coupled to the processor 1110 such that the processor 1110 can read information from, and write information to, the storage medium. In the alternative, the storage medium may be integrated into the processor 1110. Further, in some embodiments, the processor 1110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, Bluetooth, Wi-Fi, microwave, or others, then the coaxial cable, fiber optic cable, twisted pair, DSL, or wireless technologies such as infrared, radio, Bluetooth, Wi-Fi, microwave, or others can be included in the definition of medium. “Disk” and “disc,” as used herein, include compact disc (CD), laser disc, optical disc, digital versatile disc (DVD), floppy disk, and Blu-ray disc or others where disks usually reproduce data magnetically, while discs usually reproduce data optically with lasers. Combinations of the above should also be included within the scope of computer-readable media.

It should be understood by those in the art that computer system 1102 also includes power components that are operably coupled such that the system is operable. This can include one or more battery if computer system 1102 is mobile.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device 1102.

As shown in the example embodiment, a mobile computing device 1104 can also be communicatively coupled with and exchange data with network 1130. Those in the art will understand that mobile computing device 1104 can include some or all of the same or similar components as computer system 1102 coupled to constitute an operable device. Mobile computing device 1104 can be a personal digital assistant (PDA), smartphone, tablet computer, laptop, wearable computing device such as a smartwatch or smart glasses, or other device that includes one or more user interface 1106, such as a touchscreen and/or audio input/output and/or other display and user input components. Mobile computing device 1104 can also include one or more image capturing or reading component 1108 (e.g. a digital camera, scanner, or others) and associated structures and elements operatively coupled to at least one processor and memory of the mobile computing device. Such image capturing component 1108 can be operable to capture an image of a label and/or code (e.g. a quick response (QR) code or others) automatically or upon one or more user input commands.

Each of the patents and other documents identified herein are hereby incorporated in their entirety by reference herein only to the extent that the incorporated material does not conflict with existing definitions, statements, or other disclosure material set forth in this disclosure. As such, and to the extent necessary, the disclosure as set forth herein supersedes any conflicting material incorporated herein by reference. Any material, or portion thereof, that is said to be incorporated by reference herein, but which conflicts with existing definitions, statements, or other disclosure material set forth herein is only incorporated to the extent that no conflict arises between that incorporated material and the existing disclosure material.

Other embodiments of the present invention will be apparent to those skilled in the art from a consideration of the specification or a practice of the invention disclosed herein. It is intended that the specification and examples are illustrative only and are not intended to be limiting on the scope of the invention. The true scope and spirit of the present invention is indicated by the following claims.

1. A computer-implemented method for automatically creating vehicle end-user screen images, comprising:
instructions, stored in non-transitory computer readable memory that, when executed by a processor, cause the processor to perform the steps of:
automatically adding automotive data source images based on a user request received via a user interface;
two processing loops for automatically creating end-user screen images upon the request from user; and
automatically updating end-user screen images on at least one third-party listing website via a network.

2. The computer-implemented method of claim 1, wherein the automotive data source images are stored in a commercially available database.

3. The computer-implemented method of claim 2, wherein the commercially available database is selected from one of a Web Page, a Data Source or Application Programming Interface, or a File stored in memory.

4. The computer-implemented method of claim 1, wherein automatic-insertion rules stored in memory and accessed by the processor determine when to automatically insert automotive data source images for a vehicle.

5. The computer-implemented method of claim 1, wherein the two computer programming loops comprise:
a first programming loop for processing a vehicle; and
a second programming loop for processing an image.

6. A network connected computer system for automatically updating an end-user screen image based on updates from automotive data sources, comprising:
an automatic input system including implementation of auto-insertion rules by a processor for automatically adding automotive data source images upon user request on a user interface of a user device that is received via the network;
a routine monitoring system to periodically check and automatically update the end-user screen image based on detected changes from automotive data sources; and
an automatic syndication system with two computer programming loops to update the end-user screen image on at least one third-party listing website.

7. The network connected computer system of claim 6, wherein the automatic syndication system updates the image on the at least one third-party listing website.

8. The network connected computer system of claim 7, wherein updating the image on the at least one third-party listing website occurs either as a result of a trigger at a scheduled time for feed syndication or as a result of a demand for feed syndication as indicated by a user input on a user interface.

9. The network connected computer system of claim 6, wherein the automotive data source images are in a commercially available form selected from a Web Page, a Data Source/Application Programming Interface, and a File from an external automotive data source.

10. The network connected computer system of claim 6, wherein the automatic input system including implementation of auto-insertion rules determines when to automatically insert automotive data source images for a vehicle.

11. The network connected computer system of claim 6, wherein the two computer programming loops comprising a first programming loop for processing vehicle information and a second programming loop for processing an image.

12. A computer system for automatically creating and updating end-user screen images based on automotive data sources, comprising:
an automatic input system with auto-insertion rules for automatic adding automotive data source images upon user request;
an automatic creation system with two computer programming loops for automatically creating end-user screen images at the request of user via a user interface;
an automatic syndication system with two computer programming loops for automatic updating end-user screen images at third party listing websites;
a routine periodic monitoring system to automatically update end-user screen images based on the detected changes from automotive data sources.

13. The computer system of claim 12, wherein the automotive data sources are in a commercially available form selected from a Web Page, a Data Source/Application Programming Interface, and a File from an automotive data source.

14. The computer system of claim 12, including a software-based program.

15. The computer system of claim 12, wherein the process with auto-insertion rules determines when to automatically insert automotive data source images for an associated vehicle.

16. The computer system of claim 12, wherein the two computer programming loops comprise a first programming loop for processing a vehicle and a second programming loop for processing an image.

17. The computer system of claim 12, wherein the routine periodic monitoring system is a software-based computer program.
